(19) United States
(12) Patent Application Publication
(10) Pub. No.: US 2025/0153270 A1
(43) Pub. Date: May 15, 2025

(54) INSPECTION METHOD FOR LASER PROCESSING APPARATUS

(71) Applicant: DISCO CORPORATION, Tokyo (JP)

(72) Inventor: Tasuku KOYANAGI, Tokyo (JP)

(21) Appl. No.: 18/921,246

(22) Filed: Oct. 21, 2024

(30) Foreign Application Priority Data
Nov. 9, 2023 (JP) 2023-191661

(51) Int. Cl. B23K 26/03

(52) U.S. Cl. CPC B23K 26/032

(57) ABSTRACT

An inspection method for a laser processing apparatus includes a laser processing step of applying laser processing to a predetermined area of an inspection substrate by scanning the predetermined area with a pulsed laser beam by use of a laser beam scanning unit of the laser processing apparatus while causing a holding table of the laser processing apparatus to stand still in a state in which the inspection substrate is held by the holding table, an imaging step of imaging a plurality of processing marks formed in the predetermined area, after the laser processing step, and a determination step of determining whether or not there is any abnormality in the laser beam scanning unit, based on the image obtained in the imaging step.

### BACKGROUND OF THE INVENTION

### Field of the Invention

The present invention relates to an inspection method for a laser processing apparatus that inspects whether or not there is any abnormality in a laser beam scanning unit that is used for performing scanning with laser beams and a laser processing method that applies laser processing to a workpiece after the inspection is carried out.

### Description of the Related Art

In a manufacturing step of optical devices exemplified by light emitting diodes (LEDs) and laser diodes (LDs), there is a processing method called laser lift-off (LLO) processing used for relocating a plurality of optical devices formed on an epitaxy substrate such as a sapphire substrate via a buffer layer to a relocation substrate.

In LLO processing, first, after each of the optical devices is joined to the relocation substrate via a joining layer formed of metal, the buffer layer is irradiated with laser beams via the epitaxy substrate and broken. Next, the epitaxy substrate is peeled off, and each of the optical devices is relocated to the relocation substrate.

A laser processing apparatus is known as a processing apparatus for breaking the buffer layer (see, for example, Japanese Patent Laid-open No. 2013-179237). This laser processing apparatus includes a laser beam scanning unit that is capable of moving a focused spot of the laser beam within a predetermined plane.

Yet, stains adhered to a mirror, a lens, and the like configuring the laser beam scanning unit, deterioration of the mirror, the lens, and the like, malfunction of a motor or the like that operates the mirror, and the like may cause the size and shape of the focused spot, the spacing between the plurality of focused spots, and the like to vary according to the position of application of the laser beam, and the buffer layer may not sufficiently be broken in some cases.

Needless to say, replacing the laser beam scanning unit per se with a new one that is free of stain, deterioration, malfunction, or the like (that is, free of problematic processing performance) can solve the problem of insufficient breaking of the buffer layer, but this in turn poses a problem of increased cost required for laser processing. Hence, there is a demand to continue using the laser beam scanning unit even if there is some problem in the processing performance of the laser beam scanning unit.

### SUMMARY OF THE INVENTION

The present invention has been made in view of the abovementioned problem, and has as an object thereof preventing insufficient breaking of the buffer layer attributable to the processing performance of the laser processing apparatus at the time when laser processing is to be applied to the workpiece.

In accordance with an aspect of the present invention, there is provided an inspection method for a laser processing apparatus, including a laser processing step of applying laser processing to a predetermined area of an inspection substrate by scanning the predetermined area with a pulsed laser beam by use of a laser beam scanning unit of the laser processing apparatus while causing a holding table of the laser processing apparatus to stand still in a state in which the inspection substrate is held by the holding table, an imaging step of imaging a plurality of processing marks formed in the predetermined area, after the laser processing step, and a determination step of determining whether or not there is any abnormality in the laser beam scanning unit, based on an image obtained in the imaging step.

Preferably, in the determination step, whether or not there is any abnormality in the laser beam scanning unit is determined, based on at least one feature amount of a spacing between the plurality of processing marks formed on the inspection substrate, a size of each of the plurality of processing marks, or a shape of each of the plurality of processing marks.

Preferably, the determination step includes a storing step of storing the image obtained in the imaging step and coordinates corresponding to the image, in association with each other, by a controller of the laser processing apparatus, and an abnormal area identifying step of identifying an abnormal area in which scanning using the laser beam by the laser beam scanning unit has become abnormal in the inspection substrate, based on the image and the coordinates stored in the storing step.

Preferably, an informing step of, in a case where the laser beam scanning unit is determined to have abnormality in the determination step, informing an operator of the abnormality by use of at least one of a display, an indicator light, or a speaker by a controller of the laser processing apparatus is further included.

In accordance with another aspect of the present invention, there is provided a laser processing method of applying laser processing to a workpiece by use of a laser processing apparatus, the method including a preliminary processing step of applying laser processing to a predetermined area of an inspection substrate by scanning the predetermined area with a pulsed laser beam by use of a laser beam scanning unit of the laser processing apparatus while causing a holding table of the laser processing apparatus to stand still in a state in which the inspection substrate is held by the holding table, an imaging step of imaging a plurality of processing marks formed in the predetermined area, after the preliminary processing step, a storing step of storing an image obtained in the imaging step and coordinates corresponding to the image, in association with each other, an abnormal area identifying step of identifying an abnormal area in which scanning using the laser beam by the laser beam scanning unit has become abnormal in the inspection substrate, based on the image and the coordinates stored in the storing step, and a main processing step of applying laser processing to the workpiece by scanning the workpiece with the laser beam by use of the laser beam scanning unit, after the abnormal area identifying step. In the main processing step, when laser processing is to be applied to the abnormal area identified in the abnormal area identifying step, processing conditions different from those applied to a normal area that is other than the abnormal area are applied.

In the inspection method for a laser processing apparatus according to an aspect of the present invention, after the laser processing step is applied to the inspection substrate with use of the laser beam scanning unit, a plurality of processing marks formed in a predetermined area of the inspection substrate are imaged (imaging step). Then, based on the image obtained in the imaging step, whether or not there is any abnormality in the laser beam scanning unit is determined (determining step). Hence, before laser processing is applied to the workpiece, abnormality in the laser beam scanning unit can be detected. In a case where any abnormality in the laser beam scanning unit is detected, for example, changing the processing conditions makes it possible to reduce the influence caused by the abnormality in the laser beam scanning unit. Thus, when laser processing is to be applied to the workpiece, insufficient breaking of the buffer layer caused by the processing performance of the laser processing apparatus can be prevented.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a flowchart of a laser processing method according to an embodiment of the present invention;

FIG. 2 is a perspective view of a laser processing apparatus;

FIG. 3A is a side elevational view illustrating an outline of a galvanoscanner;

FIG. 3B is a plan view illustrating the outline of the galvanoscanner;

FIG. 4A is a view illustrating an outline of one example of a movement path of a focused spot in a laser processing step;

FIG. 4B is a view illustrating an outline of another example of the movement path of the focused spot in the laser processing step;

FIG. 5 is a view illustrating an imaging step;

FIG. 6 is a schematic view illustrating an example of a processing result at a time of normal operation;

FIG. 7 is a schematic view illustrating an example of a processing result including a case in which an abnormal operation has occurred;

FIG. 8 is a view illustrating a determination step;

FIG. 9 is a view illustrating an informing step;

FIG. 10 is a view illustrating a main processing step of applying laser processing to a workpiece;

FIG. 11A is a view illustrating an outline of an example of the movement path of the focused spot according to a modification; and

FIG. 11B is a view illustrating an outline of another example of the movement path of the focused spot according to the modification.

### DETAILED DESCRIPTION OF THE PREFERRED EMBODIMENT

### Embodiment

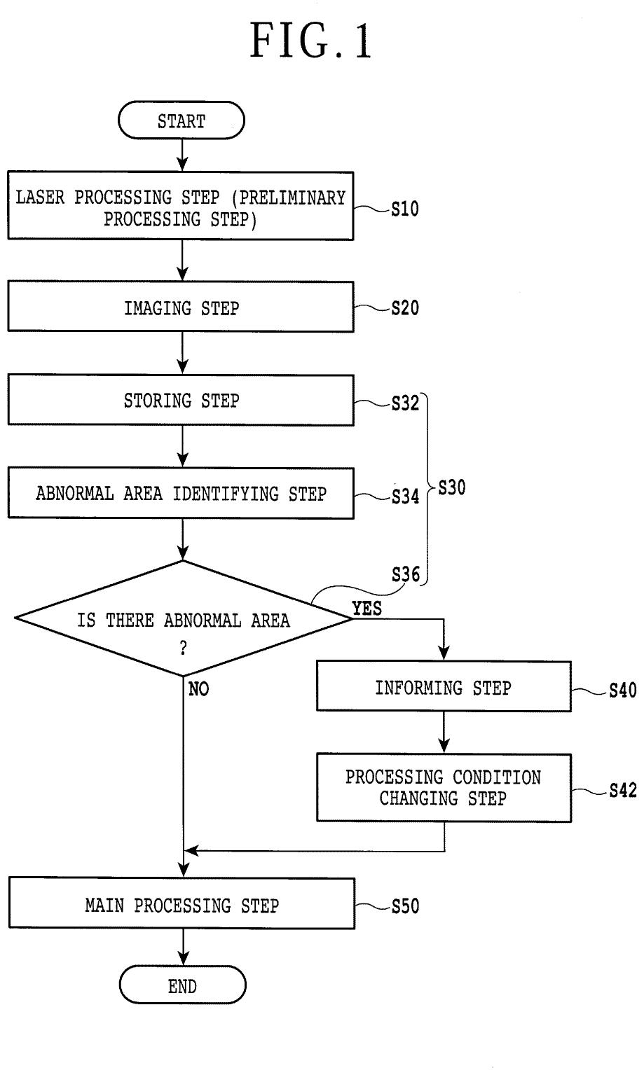

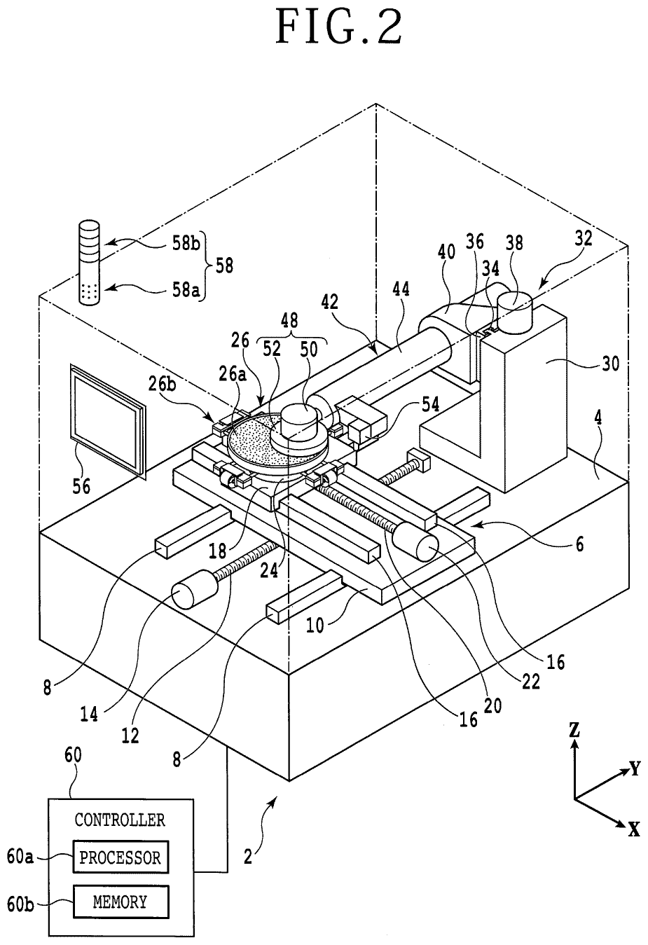

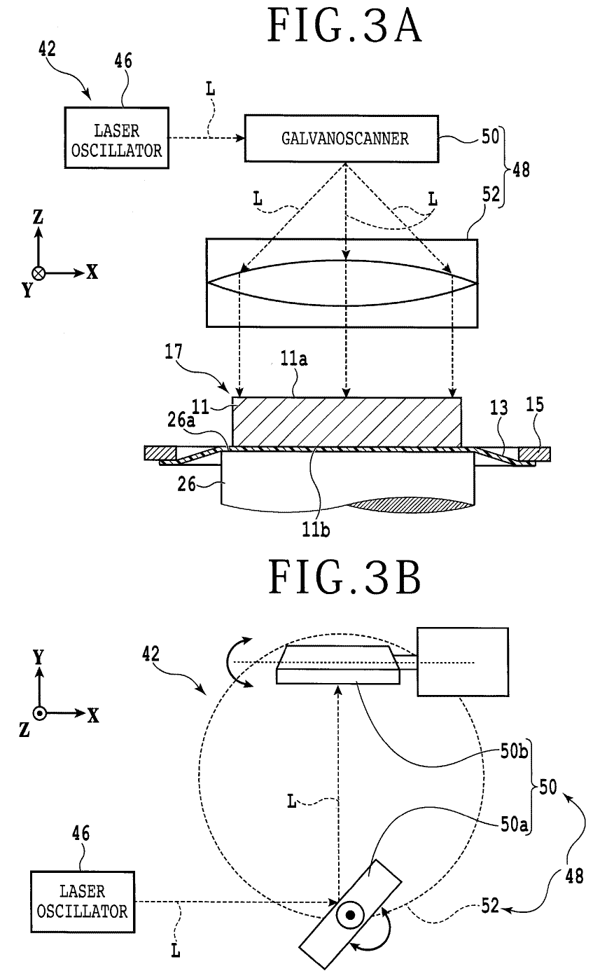

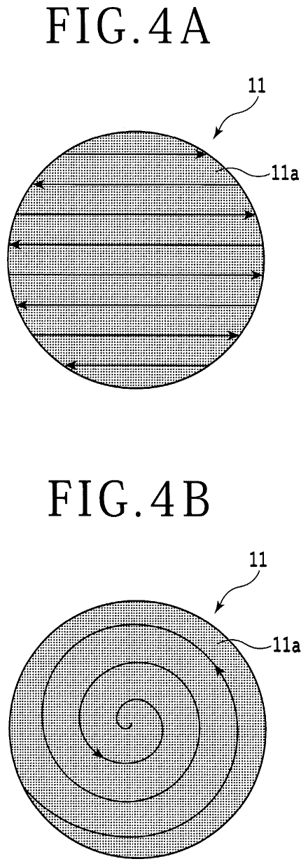

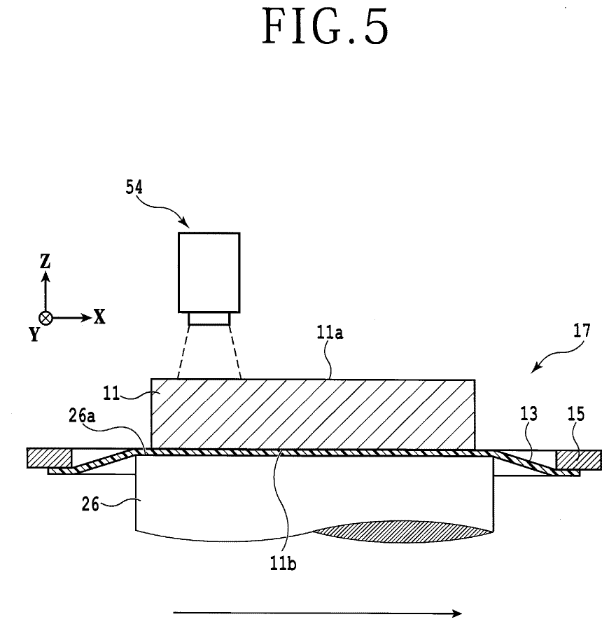

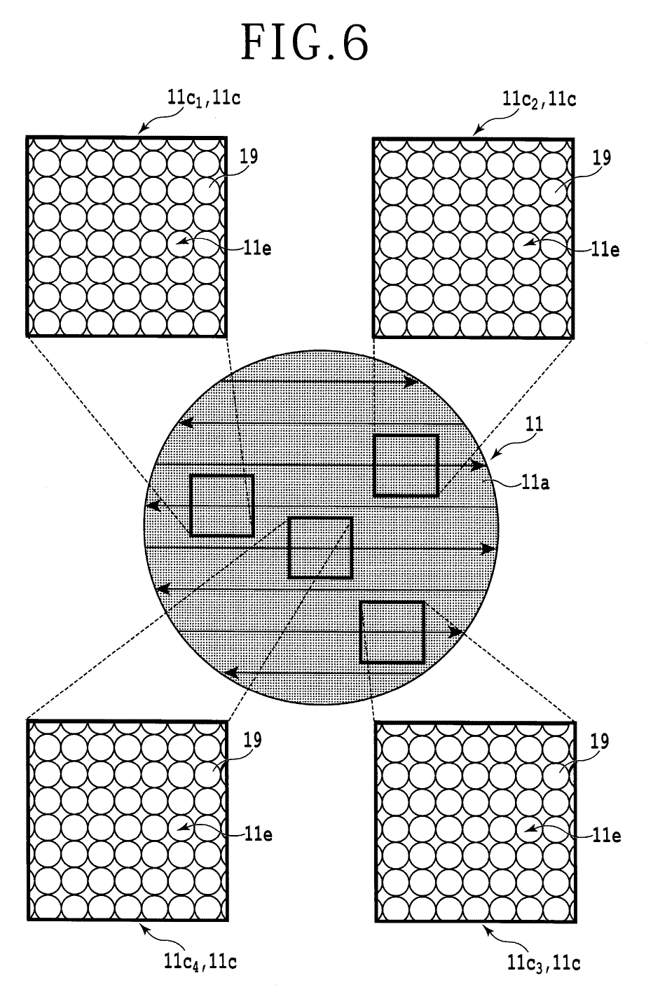

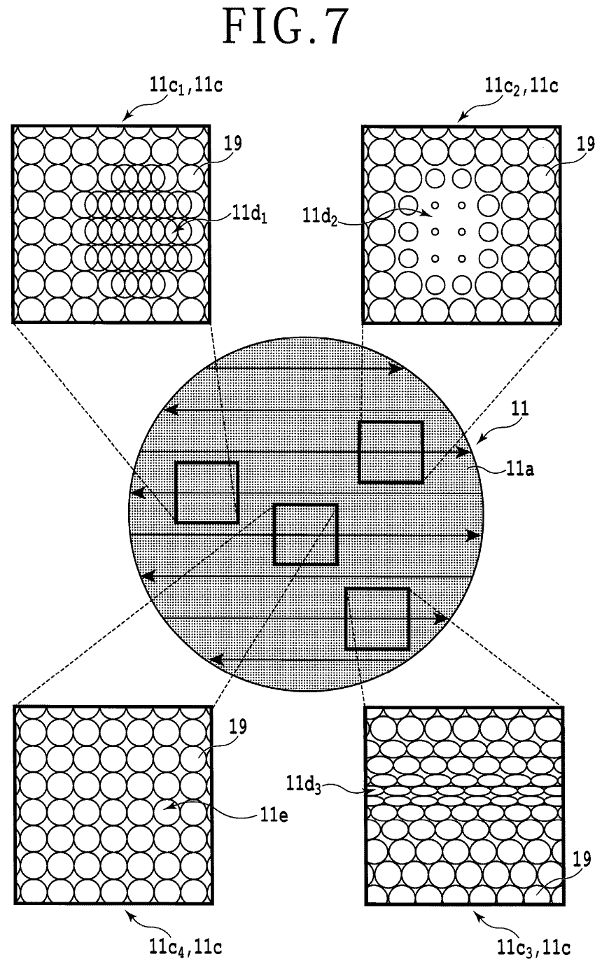

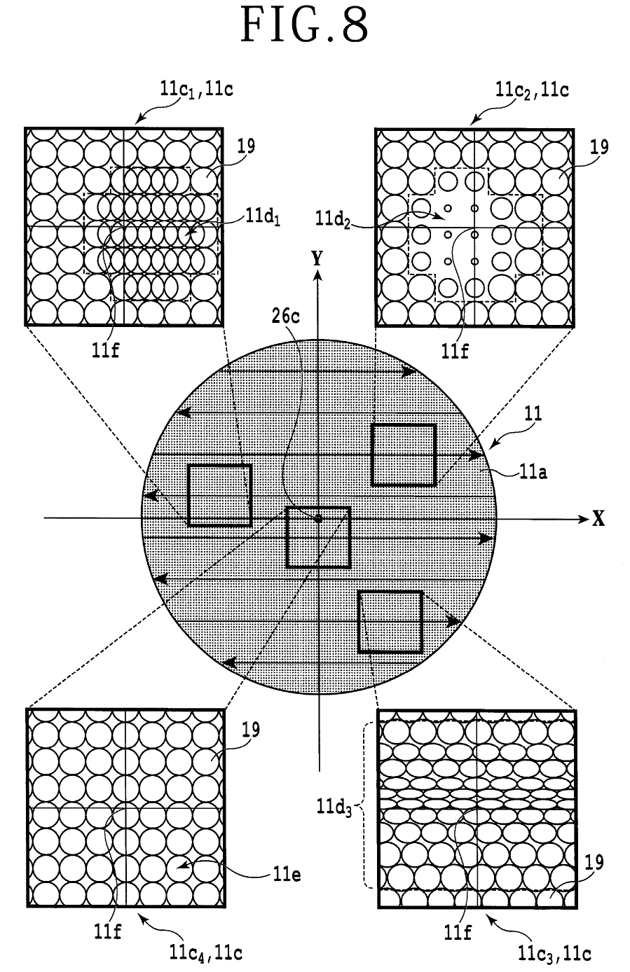

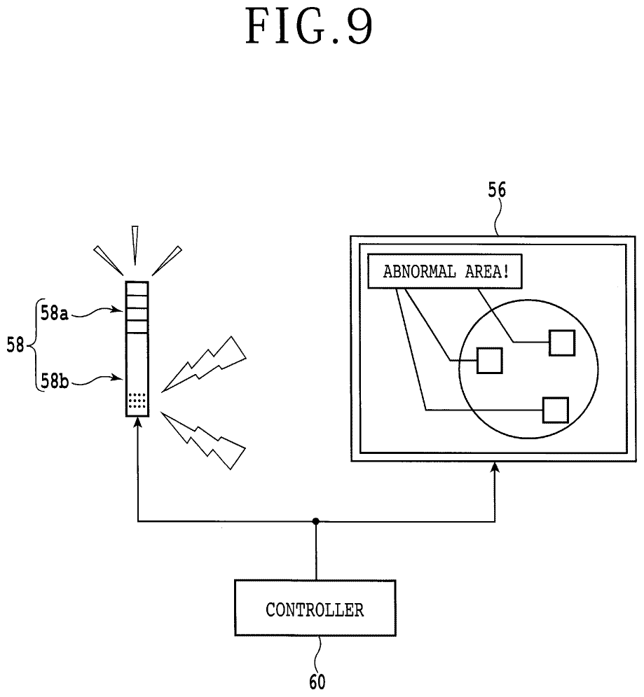

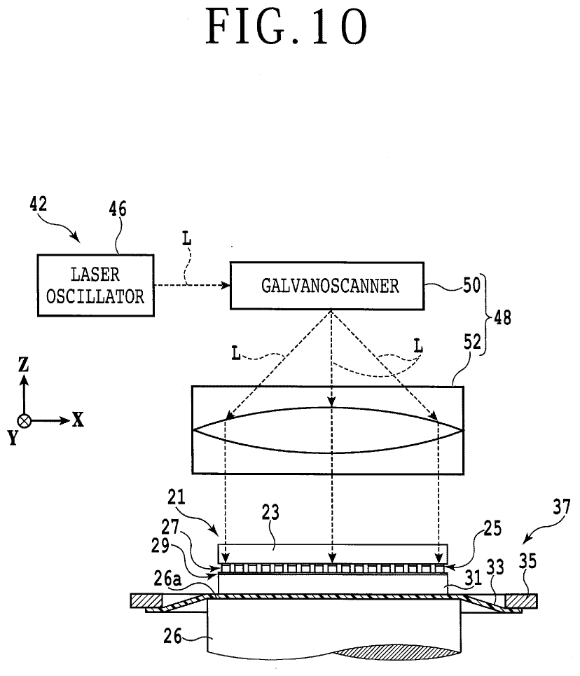

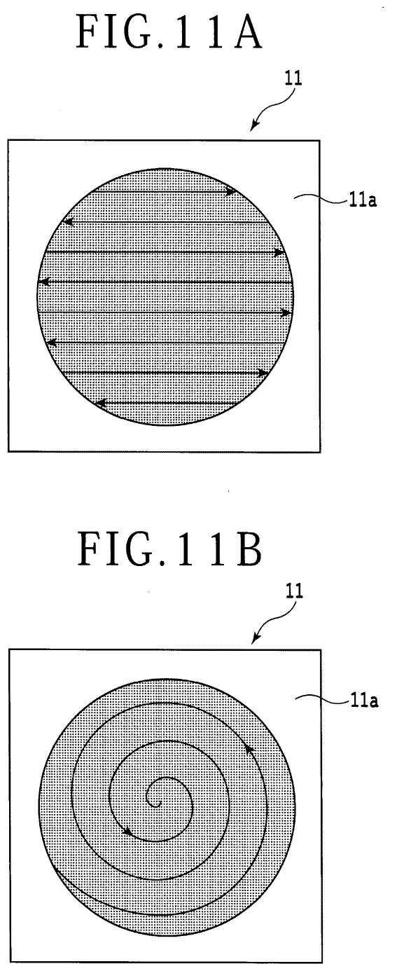

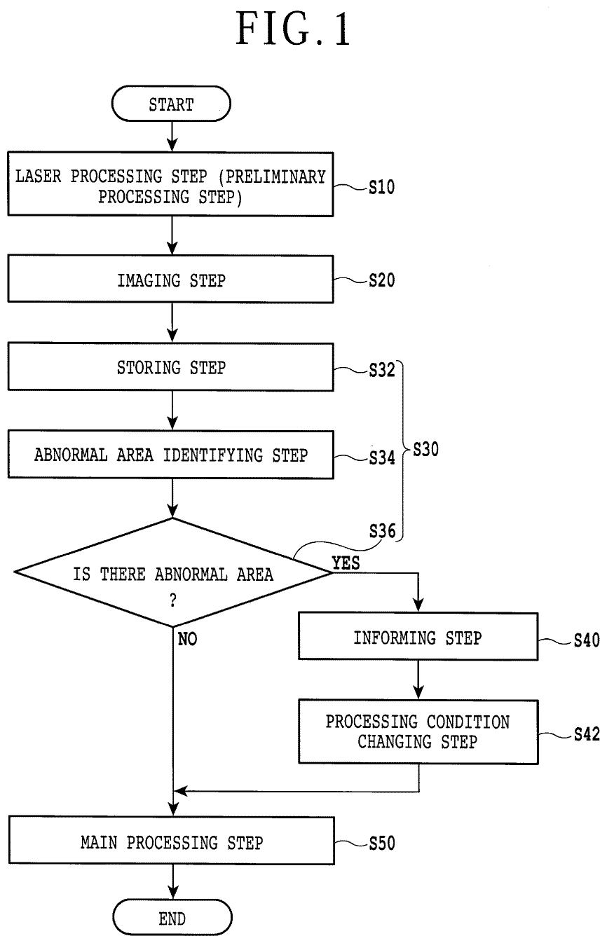

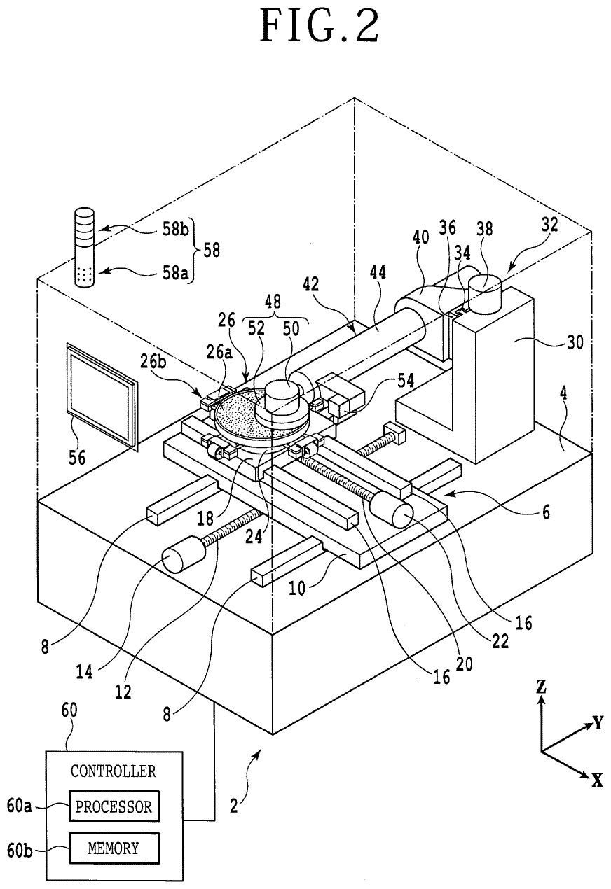

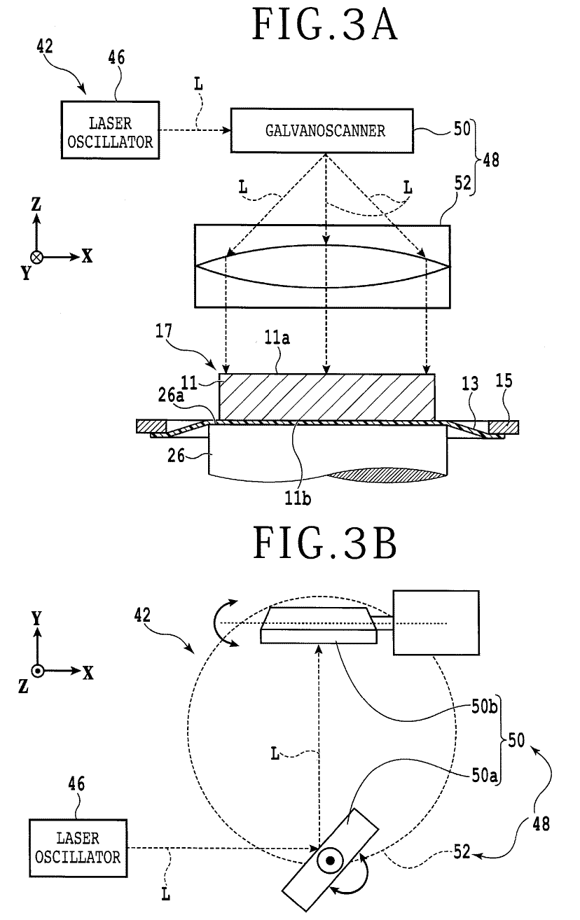

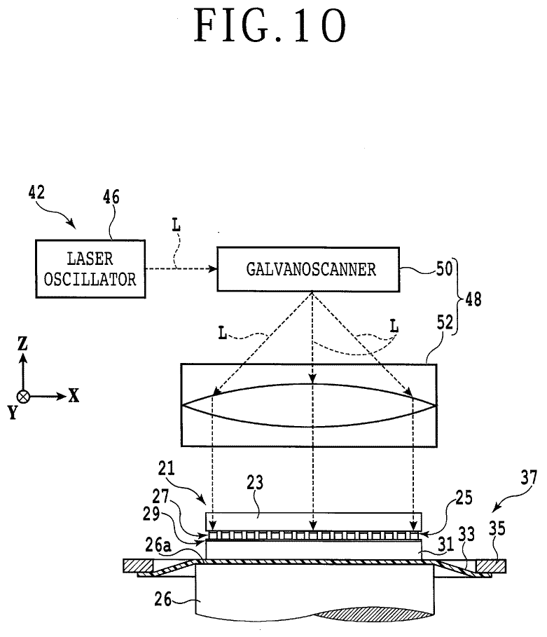

With reference to attached drawings, an embodiment according to an aspect of the present invention will be described. FIG. 1 is a flowchart of a laser processing method that applies laser processing to a workpiece 21 (see FIG. 10) with use of a laser processing apparatus 2 (see FIG. 2). The laser processing method according to the present embodiment includes (i) an inspection method for the laser processing apparatus 2 including a laser processing step (preliminary processing step) S10 for an inspection substrate 11 (see FIG. 3A), an imaging step S20, a determination step S30, and an informing step S40; and (ii) a main processing step S50 that applies laser processing to the workpiece 21 after a processing condition changing step S42 is performed. First, with reference to FIGS. 2 through 4B, the laser processing apparatus 2 used in each step will be explained.

FIG. 2 is a perspective view of the laser processing apparatus 2. An X-axis direction (processing-feed direction), a Y-axis direction (indexing-feed direction), and a Z-axis direction (up-down direction, vertical direction) each illustrated in FIG. 2 are orthogonal to one another. The laser processing apparatus 2 includes a base 4 that supports or houses constituent elements. On an upper surface of the base 4, a moving mechanism 6 is provided.

The moving mechanism 6 includes a pair of Y-axis direction guide rails 8 that are fixed on the upper surface of the base 4. The pair of Y-axis direction guide rails 8 are disposed along the Y-axis direction. To an upper portion of the pair of Y-axis direction guide rails 8, a Y-axis direction moving plate 10 is attached in a slidable manner along the pair of Y-axis direction guide rails 8. To a lower portion of the Y-axis direction moving plate 10, a nut portion (not illustrated) is fixed, and to this nut portion, a screw shaft 12 is coupled in a rotatable manner with use of a plurality of balls (not illustrated).

The screw shaft 12 is disposed along the Y-axis direction between the pair of Y-axis direction guide rails 8. To one end portion of the screw shaft 12, a driving source 14 such as a servomotor or a step motor for rotating the screw shaft 12 is coupled. When the driving source 14 is operated, the Y-axis direction moving plate 10 is moved along the Y-axis direction. The pair of Y-axis direction guide rails 8, the Y-axis direction moving plate 10, the screw shaft 12, the nut portion, the driving source 14, and the like configure a Y-axis direction moving mechanism.

Provided in the vicinity of the Y-axis direction guide rails 8 is a Y-axis direction linear scale (not illustrated) whose longitudinal direction is arranged along the Y-axis direction. Further, on a lower surface of the Y-axis direction moving plate 10, a reading head (not illustrated) that optically reads scale marks of the Y-axis direction linear scale is provided. The Y-axis direction linear scale and the reading head configure a Y-axis direction linear encoder.

To an upper portion of the Y-axis direction moving plate 10, a pair of X-axis direction guide rails 16 disposed along the X-axis direction are fixed. To an upper portion of the pair of X-axis direction guide rails 16, an X-axis direction moving plate 18 is attached in a slidable manner. To a lower portion of the X-axis direction moving plate 18, a nut portion (not illustrated) is fixed, and to this nut portion, a screw shaft 20 is coupled in a rotatable manner with use of a plurality of balls (not illustrated). The screw shaft 20 is disposed along the X-axis direction between the pair of X-axis direction guide rails 16.

To one end portion of the screw shaft 20, a driving source 22 such as a servomotor or a step motor for rotating the screw shaft 20 is coupled. When the driving source 22 is operated, the X-axis direction moving plate 18 moves along the X-axis direction. The pair of X-axis direction guide rails 16, the X-axis direction moving plate 18, the screw shaft 20, the nut portion, the driving source 22, and the like configure an X-axis direction moving mechanism. In the vicinity of the X-axis direction guide rails 16, an X-axis direction linear scale (not illustrated) whose longitudinal direction is arranged along the X-axis direction is provided.

Further, on a lower surface of the X-axis direction moving plate 18, a reading head (not illustrated) that optically reads scale marks of the X-axis direction linear scale is provided. The X-axis direction linear scale and the reading head configure an X-axis direction linear encoder. On an upper portion of the X-axis direction moving plate 18, a cylindrical table base 24 is provided.

The table base 24 includes a rotary drive source (not illustrated) such as a motor. The table base 24 has, on an upper portion thereof, a disk-shaped chuck table (holding table) 26 disposed. The chuck table 26 is rotatable about a predetermined rotational axis parallel to the Z-axis direction by the rotary drive source.

The chuck table 26 has a disk-shaped frame body formed of nonporous metal. In a central portion of the frame body, a disk-shaped recessed portion is formed in a manner exposed on an upper surface of the frame body. To this recessed portion, there is fixed a disk-shaped porous plate formed of ceramic. The frame body is formed with a flow channel in a manner connecting to the recessed portion. This flow channel is connected to a suction source (not illustrated) such as a vacuum pump. The negative pressure generated by the suction source is transmitted to an upper surface of the porous plate via the flow channel.

The annular upper surface of the frame body and the circular upper surface of the porous plate are substantially flush and function as a substantially flat holding surface 26a for holding under suction the inspection substrate 11, the workpiece 21, and the like. The holding surface 26a is disposed substantially parallel to an X-Y plane. The chuck table 26 has, on an outer circumferential portion thereof, a plurality of (four in the present embodiment) clamp units 26b at substantially equal intervals along a circumferential direction of the chuck table 26. The clamp units 26b clamp a ring frame 15 to be described later (or a ring frame 35 to be described later).

A support structure 30 is provided in a predetermined area of the base 4 that is positioned on a rear side (on one side of the Y-axis direction) of the moving mechanism 6. The support structure 30 is, on one side surface thereof that extends along a Y-Z plane, provided with a Z-axis direction moving mechanism 32. The Z-axis direction moving mechanism 32 includes a pair of Z-axis direction guide rails 34 that are fixed to the one side surface of the support structure 30 and that are disposed along the Z-axis direction. To a front surface side of the pair of Z-axis direction guide rails 34, a Z-axis direction moving plate 36 is attached in a slidable manner.

To a rear surface side of the Z-axis direction moving plate 36, a nut portion (not illustrated) is fixed. To this nut portion (not illustrated), a screw shaft (not illustrated) is coupled in a rotatable manner with use of a plurality of balls (not illustrated). The screw shaft is disposed between the pair of Z-axis direction guide rails 34 along the Z-axis direction. To an upper end portion of the screw shaft, a driving source 38 such as a servomotor or a step motor for rotating the screw shaft is coupled. When the driving source 38 is operated, the Z-axis direction moving plate 36 moves along the Z-axis direction. To a front surface side of the Z-axis direction moving plate 36, a support tool 40 is fixed.

The support tool 40 supports part of a laser beam application unit 42. The laser beam application unit 42 has a cylindrical housing 44 whose longitudinal direction is arranged along the Y-axis direction, and part of the housing 44 is supported by the support tool 40. Inside an optical box (not illustrated) placed on the base 4, a laser oscillator 46 (see FIG. 3A) is provided. The laser oscillator 46 generates a pulsed laser beam L having a predetermined wavelength (for example, 266 nm).

The laser oscillator 46 includes, for example, a laser medium such as an Nd:YAG crystal or an Nd:YVO₄ crystal, an excitation light source such as a lamp that applies excitation light to the laser medium, a switch such as a Q switch that controls the timing of emission of the laser beam L, and a non-linear crystal such as Cesium Lithium Borate (CLBO) and Lithium Triborate (LBO) (both of which are not illustrated). To a distal end portion of the housing 44, a laser beam scanning unit 48 is fixed. The laser beam scanning unit 48 includes a galvanoscanner 50 that is used for scanning the predetermined plane arranged substantially parallel to the X-Y plane with the laser beam L.

FIG. 3A is a side elevational view illustrating an outline of the galvanoscanner 50, while FIG. 3B is a plan view illustrating the outline of the galvanoscanner 50. The galvanoscanner 50 includes a first mirror 50a that moves the focused spot along the X-axis direction and a second mirror 50b that moves the focused spot along the Y-axis direction. The first mirror 50a has a rotational axis arranged along the Z-axis direction and a reflection surface that is configured to be rotatable in a predetermined angular range in the X-Y plane. Further, the second mirror 50b has a rotational axis arranged along the X-axis direction and a reflection surface that is configured to be rotatable in a predetermined angular range in the Y-Z plane.

The laser beam L reflected by the galvanoscanner 50 passes through a fθ lens (i.e., telecentric fθ lens) 52 to be applied substantially vertically to the holding surface 26a. The focused spot of the laser beam L applied to the holding surface 26a through the fθ lens 52 normally has substantially the same diameter irrespective of the position in the X-Y plane. The laser beam scanning unit 48 moves the focused spot of the laser beam L along the X-Y plane.

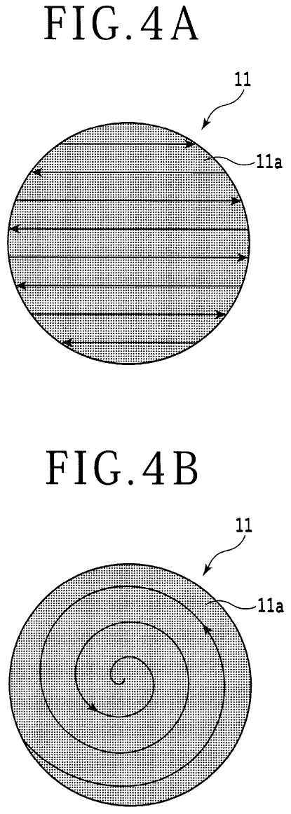

The laser beam scanning unit 48 repeats a series of steps of, for example, moving the focused spot in one direction along the X-axis direction, then in the Y-axis direction by a predetermined distance, next in the other direction along the X-axis direction, and then along the Y-axis direction again by a predetermined distance (see FIG. 4A). Further, for example, the laser beam scanning unit 48 moves the focused spot of the laser beam L such that the laser beam L follows a spiral path (that is, in a such a manner that the more it turns, the more it comes closer to the turning center) (see FIG. 4B). Note that the galvanoscanner 50 may move the focused spot in such a manner that the more it turns, the farther it becomes from the turning center.

Incidentally, a plurality of polygon mirrors (not illustrated) may be used in place of the galvanoscanner 50, and a piezo scanner (not illustrated) may be used as the laser beam scanning unit 48. Further, any two of the galvanoscanner 50, the polygon mirror, and the piezo scanner may be combined for use. Further, the polygon mirror and an acousto-optic deflector (AOD) may be combined for use. In short, the laser beam scanning unit 48 is only required to be able to move the focused spot of the laser beam L along the X-Y plane.

Here, reference will be made to FIG. 2 again. To the side surface of the distal end portion of the housing 44, a microscopic camera unit 54 is fixed in such a manner as to be able to face the holding surface 26a. The microscopic camera unit 54 includes an objective lens and an image capturing element such as a charge-coupled device (CCD) image sensor or a complementary metal-oxide-semiconductor (CMOS) image sensor.

The microscopic camera unit 54 according to the present embodiment is an area sensor camera capable of imaging a plane area of a predetermined size, but may alternatively be a line sensor camera capable of imaging a linear area of a predetermined length. Moreover, the microscopic camera unit 54 may be provided with both the area sensor camera and the line sensor camera. The microscopic camera unit 54 is provided with a light source such as an LED for lighting the imaging subject. The housing 44, the laser beam scanning unit 48, the microscopic camera unit 54, and the like are movable in a unified manner along the Z-axis direction by the Z-axis direction moving mechanism 32.

On the base 4, an external panel that covers the constituent elements is provided. FIG. 2 illustrates the external panel in a dash-dotted line. On a front side surface of the external panel, a touch panel 56 is provided. The touch panel 56 is a display such as a liquid crystal display or an organic LED (OLED) display that functions as an input apparatus and a display apparatus.

For example, an operator can input processing conditions to the laser processing apparatus 2 via the touch panel 56 and can also look at a graphical user interface (GUI), input processing conditions, images obtained by the microscopic camera unit 54, and the like, via the touch panel 56. Note that, in place of the touch panel 56, a display apparatus having no function of an input apparatus may be provided. In this case, an input apparatus (keyboard, mouse, trackball, touch pad, digitizer, or the like) for an operator to input instructions will separately be provided.

On a top surface of the external panel, a cylindrical indicator light 58 is provided. The indicator light 58 has a base portion 58a in which a speaker (not illustrated) is built. Note that the speaker may be provided in the laser processing apparatus 2 separately from and independently of the indicator light 58. On the base portion 58a, a light emitting portion 58b capable of emitting light in different colors is provided. The light emitting portion 58b has a plurality of light emitting areas disposed in such a manner to overlap in the Z-axis direction. The plurality of light emitting areas each include an LED and diverging lenses provided in a manner surrounding the LED. The plurality of light emitting areas can be lit or blink in predetermined colors different from one another such as red, yellow, blue, and green.

The operations of the moving mechanism 6, the Z-axis direction moving mechanism 32, the laser beam application unit 42, the microscopic camera unit 54, the touch panel 56, the indicator light 58, and the like are controlled by a controller 60. Note that, in FIG. 2, for the convenience of description, the controller 60 is illustrated outside the laser processing apparatus 2, but, in reality, the controller 60 is disposed inside the base 4 or on an inner side of the external panel. The controller 60 is, for example, configured by a computer including a processor 60a represented by a central processing unit (CPU) and a memory 60b.

The memory 60b includes a main storage device, such as a dynamic random access memory (DRAM), and an auxiliary storage device such as a flash memory, a hard disk drive, or a solid state drive. In the auxiliary storage device, software including a predetermined program is stored. By the processor 60a and the like being operated according to this software, the functions of the controller 60 are realized. Note that the controller 60 also includes, in addition to the function of controlling the operation of the laser processing apparatus 2, a function of performing image processing on the images obtained by the microscopic camera unit 54.

Next, description will be given of the inspection substrate 11 to which laser processing is applied in the steps ranging from the laser processing step S10 to the informing step S40 in the inspecting method for the laser processing apparatus 2. The inspection substrate 11 is a disk-shaped wafer formed of singly crystal silicon. The inspection substrate 11 is a dummy wafer used for inspecting whether or not there is any abnormality in the laser beam scanning unit 48, and has a diameter substantially equal to that of the workpiece 21. Yet, the inspection substrate 11 is only required to have the same shape and size as the workpiece 21.

Both the inspection substrate 11 and the workpiece 21 normally have a disk shape, but may alternatively have a rectangular plate shape or any other shape. Yet, the inspection substrate 11 and the workpiece 21 may have different thicknesses. The inspection substrate 11, for example, satisfies the requirements defined in Semiconductor Equipment and Materials International (SEMI) M18 or SEMI M24 in the Semiconductor Equipment and SEMI standard. Note that, while the inspection substrate 11 is not provided with the abovementioned optical devices, the workpiece 21 is.

When laser processing is to be applied to the inspection substrate 11, as illustrated in FIG. 3A, an inspection substrate unit 17 in which the inspection substrate 11, a tape 13, and the ring frame 15 are integrated is formed. Specifically, first, the inspection substrate 11 is disposed on an opening portion of the ring frame 15. Next, the tape 13 having a circular shape is affixed to one side of the ring frame 15 and one side 11b of the inspection substrate 11, so that the inspection substrate unit 17 is formed. In the inspection substrate unit 17, the inspection substrate 11 is supported by the ring frame 15 made of metal via the tape 13 made of resin.

Next, steps ranging from the laser processing step S10 to the informing step S40 will be described. In the laser processing step S10, first, the inspection substrate unit 17 is placed on the chuck table 26. Next, the ring frame 15 is clamped by the clamp units 26b, and the inspection substrate 11 is held under suction on the holding surface 26a via the tape 13. In this state, the chuck table 26 is caused to stand still directly below the laser beam scanning unit 48.

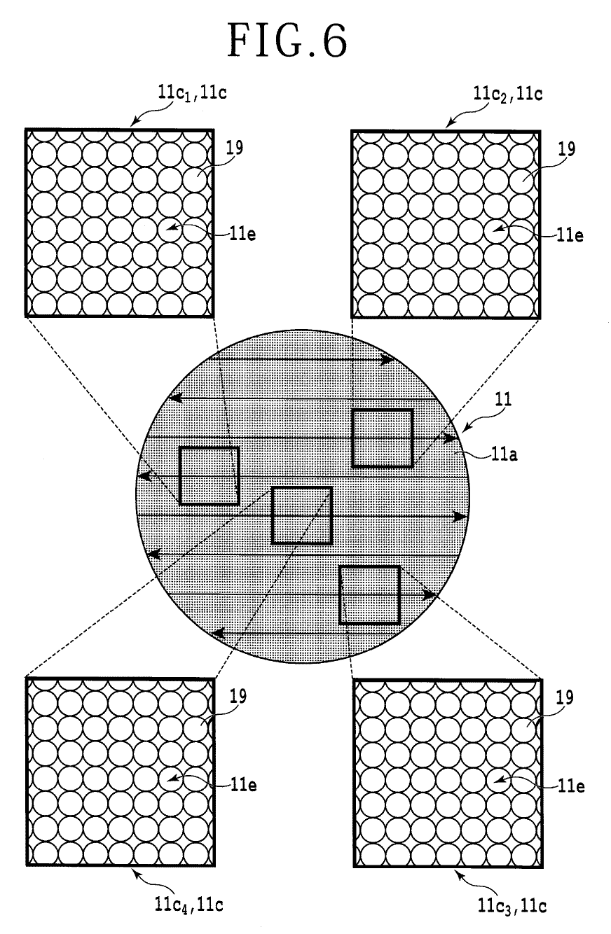

Next, the laser beam scanning unit 48 is used to scan the other side 11a of the inspection substrate 11 with the laser beam L, and laser processing is applied to substantially the whole (that is, a predetermined area) of the other side 11a of the inspection substrate 11 (laser processing step S10). For example, as a result of applying the laser beam L corresponding to a predetermined number of pulses to the inspection substrate 11, one processing mark 19 (see FIG. 6) is formed on the other side 11a of the inspection substrate 11. Scanning the other side 11a with the laser beam L forms a plurality of processing marks 19 on the other side 11a. Note that, in the present embodiment, applying laser processing to the whole of the other side 11a of the inspection substrate 11 does not mean evenly forming a plurality of processing marks 19 on the whole of the other side 11a without any space.

In the present embodiment, the plurality of processing marks 19 are formed with the focused spot having a circular or oval shape or any other similar shape and a plane disposed substantially parallel to the X-Y plane being scanned with the pulsed laser beam L by the laser beam scanning unit 48, and hence, an unprocessed area will inevitably be present near adjacent processing marks 19. That is, the plurality of processing marks 19 are not necessarily evenly formed over the entire other side 11a without any space. The other side 11a has areas where the plurality of processing marks 19 neither contact nor overlap with each other.

In a case where there is no problem in the processing performance of the laser beam scanning unit 48, when laser processing is applied to the whole of the other side 11a of the inspection substrate 11, the spacing between two adjacent processing marks 19 in the scanning direction of the laser beam L becomes substantially uniform or the overlapping ratio (ratio of the area of a portion where two processing marks 19 overlap with each other to the area of one processing mark 19) between the two processing marks 19 becomes substantially constant. Note that, in the plane in which scanning with the laser beam L is carried out, while the spacing (or the overlapping ratio) between two processing marks 19 adjacent in the direction perpendicular to the scanning direction of the laser beam L is determined as appropriate in the processing conditions, normally, the spacing (or the overlapping ratio) between two processing marks 19 in the scanning direction is set to be the same.

FIG. 4A is a view illustrating an outline of an example of a movement path of the focused spot of the laser beam L in the laser processing step S10. Needless to say, in practice, scanning with the laser beam L is performed in such a manner that the spacing between the movement tracks adjacent in the direction perpendicular to the movement track of the focused spot becomes denser than that illustrated in FIG. 4A. In a case where the focused spot is to be moved back and forth as illustrated in FIG. 4A, the moving speed of the focused spot is made constant regardless of the position in the other side 11a. One example of the processing conditions in the laser processing step S10 is illustrated below.
Wavelength: 266 nm
Average output: 0.1 W to 2 W
Pulse energy: 0.5 μJ to 10 μJ
Repetition frequency: 50 kHz to 200 kHz
Spot diameter: 10 μm to 50 μm
Defocus amount: upward mm for 0.5 to 2 mm (from the other side 11a)
Scanning speed: 50 mm/s to 100 mm/s

In the example illustrated in FIG. 4A, while the focused spot is moved from an outer peripheral edge to another outer peripheral edge in the other side 11a in such a manner as to move across the other side 11a by moving in one direction or the other direction along the lateral direction of the other side 11a, the focused spot is also moved stepwise from one end portion to the other end portion of the other side 11a along the longitudinal direction. Note that, in the laser processing step S10, the scanning speed is so adjusted to make the spacing between the geometric centers of the focused spot in the scanning direction substantially constant.

Such conditions as the absorption rate of the laser beam L by the inspection substrate 11 are made substantially constant regardless of the location in the other side 11a. Hence, when there is no abnormality in the processing performance of the laser processing apparatus 2, substantially constant spacing between the geometric centers of the focused spot leads to substantially constant spacing between the geometric centers of a plurality of processing marks 19 in the scanning direction. For example, if the motor (actuator) configuring the galvanoscanner 50 operates normally, and unless there is any substance adhering to the first mirror 50a, the second mirror 50b, and the fθ lens 52 and substantial deterioration of the components, substantially constant spacing between the geometric centers of the focused spot leads to substantially constant spacing between the geometric centers of the plurality of processing marks 19 in the scanning direction.

FIG. 4B is a diagram illustrating an outline of another example of the movement path of the focused spot in the laser processing step S10. Needless to say, in practice, scanning with the laser beam L is performed in such a manner that the spacing between the adjacent movement tracks becomes denser than that illustrated in FIG. 4B. In the laser processing step S10, since the spacing between the geometric centers of the focused spot is made substantially constant, in a case where the focused spot is moved in a spiral shape as illustrated in FIG. 4B, the moving speed of the focused spot becomes slower as it approaches the center of the other side 11a.

The focused spot, for example, starts moving from one point in the outer peripheral edge of the other side 11a, approaches the turning center as it turns, and finally reaches the turning center. Conversely, the focused spot may start moving from the turning center, move farther from the turning center as it turns, and finally reach a point in the outer peripheral edge. In this case, the moving speed of the focused spot becomes faster as it moves farther from the turning center.

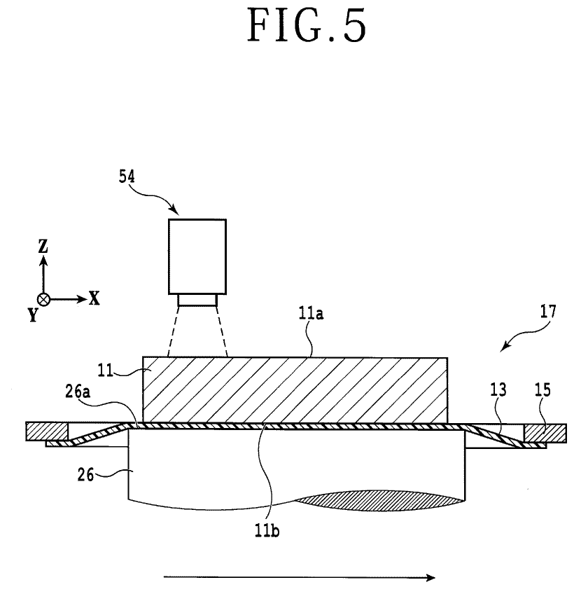

After the laser processing step S10, the whole (that is, the predetermined area) of the other side 11a of the inspection substrate 11 is imaged, so that all of the processing marks 19 (the plurality of processing marks 19) formed on the other side 11a are imaged (imaging step S20). FIG. 5 is a view illustrating the imaging step S20. In the imaging step S20, for example, the microscopic camera unit 54 including an area sensor camera is used. After a partial area of the other side 11a is imaged by the microscopic camera unit 54, the chuck table 26 is moved along the X-axis direction by a predetermined distance such that an area imaged in the first imaging by the microscopic camera unit 54 and the area imaged in the second imaging slightly overlap with each other in the X-axis direction.

Further, after an image of the partial area is obtained in the second imaging, the chuck table 26 is moved along the X-axis direction by a predetermined distance, and then, the third imaging is performed. In this manner, after a group of images of a first band area whose longitudinal direction extends in the X-axis direction is obtained by a plurality of partial areas being imaged, the chuck table 26 is moved along the Y-axis direction by a predetermined distance.

Further, as in the case where the group of images of the first band area has been obtained, the chuck table 26 is moved stepwise along the X-axis direction, while parts of the other side 11a are each imaged at the positions where the chuck table 26 stands still, so that a group of images of a second band area whose longitudinal direction extends in the X-axis direction is obtained. The first band area and the second band area slightly overlap with each other in the Y-axis direction. In this manner, acquiring a plurality of groups of images and piecing them together by image processing make it possible to obtain an overall image of the other side 11a. Needless to say, a microscopic camera unit 54 having a line sensor camera instead of an area sensor camera may be used.

FIG. 6 is a schematic diagram illustrating an example of a processing result at a time of a normal operation of the laser processing apparatus 2. In FIG. 6, of the overall image, images 11c1 to 11c4 of the plurality of partial areas are illustrated in an enlarged form. Each of the images 11c1 to 11c4 includes only a normal area 11e on which normal laser processing has been performed. Note that, as illustrated in FIG. 6, forming the plurality of processing marks 19 such that adjacent processing marks 19 do not overlap with each other but come into contact with each other or slightly separate from each other makes it possible to recognize the shape of a single processing mark 19. This brings about such an advantage that such image processing as pattern recognition for the processing mark 19 becomes easy compared to the case where the processing marks 19 are so formed that adjacent processing marks 19 overlap with each other.

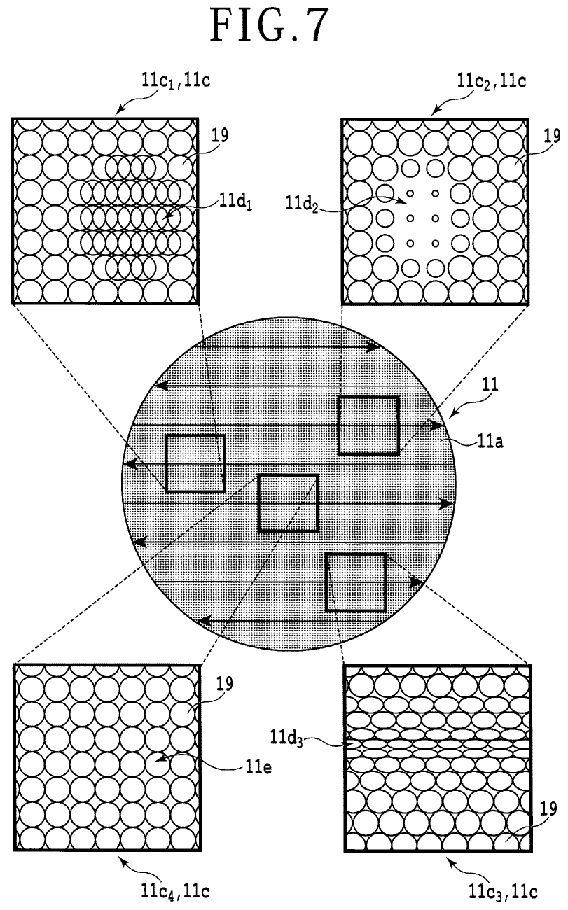

FIG. 7 is a schematic view illustrating an example of a processing result including a case where an abnormal operation has occurred in the laser processing apparatus 2. Note that, in FIG. 7, of the overall image, the images 11c₁ to 11c₃ corresponding to abnormal areas 11d₁ to 11d₃ and the image 11c₄ including only the normal area 11e are illustrated in an enlarged form. In the image 11c₁, as a result of the focused spot moving at a scanning speed different from a predefined setting value due to malfunction of the motor, there is an abnormal area 11d₁ in which a plurality of processing marks 19 overlap with each other in the scanning direction. That is, in the abnormal area 11d₁, the abnormal operation of the laser beam scanning unit 48 is reflected.

Such malfunction of the motor occurs at local areas on the movement track of the focused spot. This conversely means that the laser beam scanning unit 48 is operating normally at areas other than these local areas on the movement track of the focused spot. Further, in image 11c₂, for example, there is an abnormal area 11d₂ in which the energy density of the laser beam L is reduced and the size of the processing mark 19 is small due to adhering substances present on the path on the fθ lens 52 through which the laser beam L passes. That is, in the abnormal area 11d₂, the abnormal operation of the laser beam scanning unit 48 is reflected.

In the image 11c₃, there in an abnormal area 11d₃ in which the processing marks 19 have a shape (for example, an oval shape) different from the predefined shape as a result of the shape of the focused spot of the laser beam L being distorted from the predefined shape (for example, a true circle) due to the influence of the adhering substances or deterioration of the mirrors and/or the fθ lens 52. That is, in the abnormal area 11d₃, the abnormal operation of the laser beam scanning unit 48 is reflected. Such reduced energy density of the focused spot occurs at local areas on the movement track of the focused spot. This conversely means that, at areas other than these local areas on the movement track of the focused spot, the laser processing apparatus 2 is operating normally.

As described above, the laser beam scanning unit 48 operating abnormally refers to, for example, the actuator of the galvanoscanner 50 operating abnormally as exemplified by the focused spot moving at a scanning speed different from the predefined setting value or any cause of reduced energy density of the focused spot being present on the optical path of the laser beam L in the mirrors and/or the fθ lens 52.

In contrast, in the image 11c₄, the abnormal operation of the laser processing apparatus 2 is not reflected, and when laser processing is applied to a range included in the image 11c₄, the laser beam scanning unit 48 operates normally. In the present embodiment, the laser beam scanning unit 48 operating normally refers to, for example, the motor configuring the galvanoscanner 50 operating normally and no cause of reduced energy density of the focused spot substantially being present on the mirrors and the fθ lens 52.

In one example, in a case where the laser beam scanning unit 48 is operating normally, the processing marks 19 do not overlap with each other unlike in the abnormal area 11d₁, the sizes of the processing marks 19 are not small compared to other processing marks 19 in the surrounding unlike in the abnormal areas 11d₂ and 11d₃, and the shape of each of the processing marks 19 is the same as that of other processing marks 19 in the surrounding as in the normal area 11e.

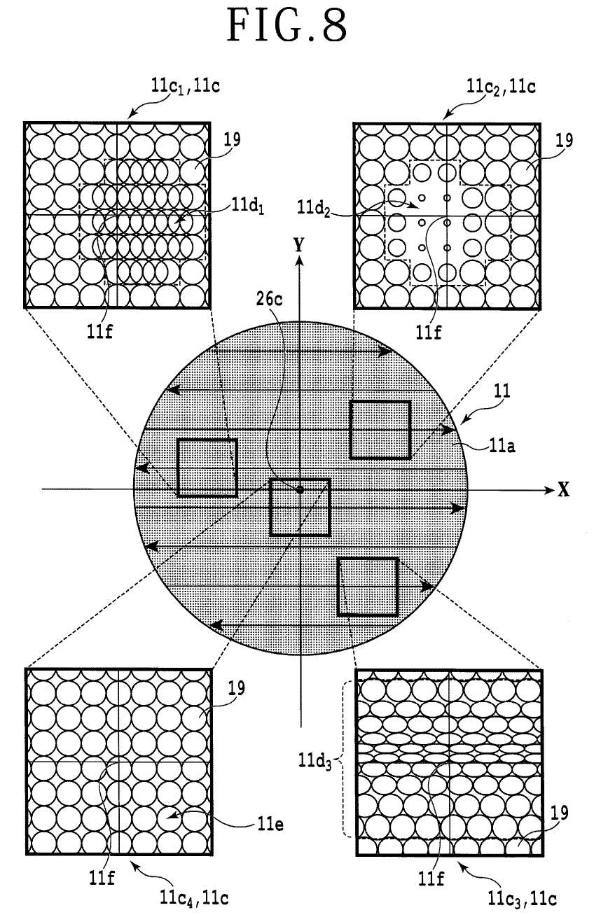

After the imaging step S20, processing flows to a storing step S32 configuring the determination step S30. FIG. 8 is a view illustrating the storing step S32 in the determination step S30. In the storing step S32, the controller 60 stores the images 11c obtained in the imaging step S20 and the coordinates corresponding to the images 11c, in association with each other. The coordinates corresponding to the images 11c are calculated by the controller 60 with use of, for example, the center 26c of the holding surface 26a corresponding to the intersection of the rotational axis of the chuck table 26 and the holding surface 26a, as the origin.

Note that, in the example illustrated in FIG. 8, the center of the inspection substrate 11 in the radial direction and the center 26c of the holding surface 26a match in the X-Y plane, but the two are not required to completely match. The position of the center of the inspection substrate 11 in the radial direction can be identified by imaging three different points on the outer circumferential portion of the inspection substrate 11. Hence, in a case where the center of the inspection substrate 11 in the radial direction deviates from the center 26c, it is only required that the coordinates of the image 11c corresponding to the center 26c be corrected according to this deviation.

Since the controller 60 uses the X-axis and Y-axis direction linear encoders to obtain the initial position, the amount of movement, and the like of the chuck table 26 by the moving mechanism 6, for example, the controller 60 recognizes the coordinates of the representative position (for example, a center position 11f) of the imaging area at the time of acquisition of the image 11c₁ as the coordinates corresponding to the image 11c. Note that, while the coordinates corresponding to the image 11c are obtained with the center 26c of the holding surface 26a used as the origin, in theory, the coordinates may be calculated with reference to a predetermined position in the inspection substrate 11. This predetermined position may be a notch of the inspection substrate 11 or a center of the other side 11a of the inspection substrate 11 calculated from an image obtained by imaging the inspection substrate 11.

The controller 60 stores the image 11c and the coordinates corresponding to the image 11c in association with each other. Note that, in the case of a line sensor camera, the controller 60 may store one overall image and the coordinates of the representative position (for example, the center position) of the overall image in association with each other or may store an image obtained by binding a plurality of lines into one and coordinates of the representative position (for example, the center position) of the image in association with each other.

After the storing step S32, the controller 60 identifies the abnormal area 11d₁ and the like in which the scanning using the laser beam L by the laser beam scanning unit 48 has become abnormal in the inspection substrate 11, based on the images 11c and the coordinates corresponding to the images 11c stored in the memory 60b in the storing step S32 (abnormal area identifying step S34). At this time, the spacing between two adjacent processing marks 19 (or the overlapping ratio between two adjacent processing marks 19), the size of the processing mark 19, and the shape of the processing mark 19 each serve as the feature amount to be used in identifying the abnormal area.

The controller 60 stores in advance, for example, an allowable range of the spacing between two adjacent processing marks 19 (or the overlapping ratio between two adjacent processing marks 19), an allowable range of the size of the processing mark 19, and a threshold value indicating the degree of deviation from an ideal shape. In the abnormal area identifying step S34, the controller 60 determines whether or not the spacing between the plurality of adjacent processing marks 19 is within the allowable range, whether or not each processing mark 19 has a size within the allowable range, and whether or not the degree of deviation from an ideal shape is less than the threshold value, by the image processing on the images 11c.

Further, in the abnormal area identifying step S34, the controller 60 identifies, for example, how long a range of the area corresponding to the abnormal area 11d₁ extends in the X-axis direction and the Y-axis direction with the center position 11f being used as the reference position, by image processing. Since the unit length (for example, one pixel) in the images 11c is defined in advance as to correspond to a predetermined length (for example, 1 μm), the controller 60 can identify the range of XY coordinates in which the abnormal areas 11d₁, 11d₂, and 11d₃, for example, are present in the images 11c, by image processing.

After the abnormal area identifying step S34, the controller 60 determines whether or not there is any abnormality in the laser beam scanning unit 48, based on at least one feature amount of the spacing between the plurality of processing marks 19 formed on the inspection substrate 11 (see image 11c₁), the size of the processing marks 19 (see image 11c₂), or the shape of the processing marks 19 (see image 11c₃) (S36 in FIG. 1).

As described above, in the determination step S30 including steps S32, S34, and S36, the controller 60 determines whether or not each image 11c includes the abnormal area 11d₁ and the like (that is, whether or not there is any abnormality in the laser beam scanning unit 48) based on the plurality of images 11c obtained in the imaging step S20. Thus, abnormality in the laser beam scanning unit 48 can be detected before laser processing is applied to the workpiece 21.

In a case where the controller 60 determines that there is abnormality in the laser beam scanning unit 48 in the abnormal area identifying step S34 (YES in S36), the controller 60 uses at least one of the touch panel 56, the indicator light 58, or the speaker (see the base portion 58a) to inform the operator of the abnormality (informing step S40).

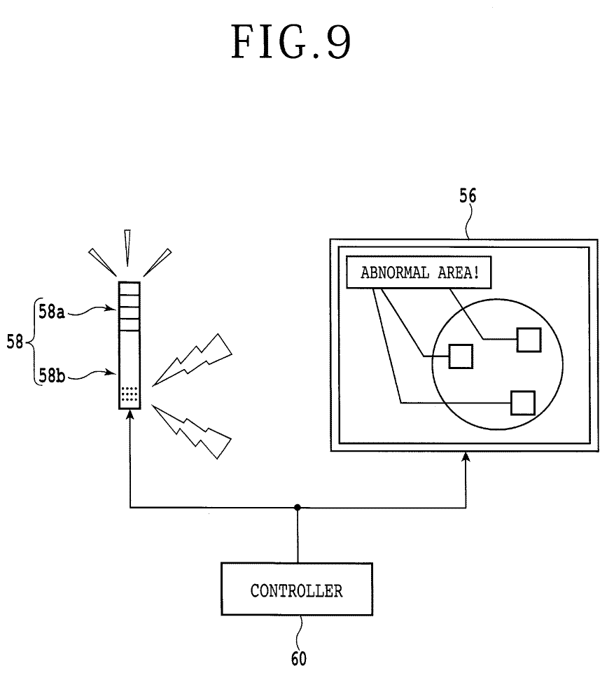

FIG. 9 is a view illustrating the informing step S40. In the processing condition changing step S42 after the informing step S40, the operator changes the processing conditions to be used in the subsequent main processing step S50. For example, the operator sets the processing conditions in the controller 60 via the touch panel 56 in such a manner that the scanning speed becomes slow in the abnormal area 11d₁ in which a plurality of processing marks 19 are overlapping with one another in the scanning direction compared to that in the normal area 11e on which normal laser processing has been performed.

Alternatively, for example, the operator sets the processing conditions in the controller 60 via the touch panel 56 in such a manner that, in the abnormal area 11d₂ in which the size of the processing mark 19 is small, the energy density of the laser beam L becomes high compared to that in the normal area 11e. As a still alternative, for example, the operator sets the processing conditions in the controller 60 via the touch panel 56 in such a manner that, in the abnormal area 11d₃ in which the shape of the processing mark 19 is different from the predefined shape, processing similar to the one performed on the normal area 11e can be carried out by changing the application position of the laser beam L in the X-Y plane and increasing the energy density of the laser beam L.

After the processing condition changing step S42, the processing flows to the main processing step S50. In the manner described above, in the processing condition changing step S42, processing conditions different from those applied to the normal area 11e that is other than the abnormal areas 11d₁, 11d₂, and 11d₃ are set to locally apply the changed processing conditions to areas corresponding to the abnormal areas 11d₁, 11d₂, and 11d₃, in the main processing step S50. Incidentally, in a case where the controller 60 determines that there is no abnormality in the laser beam scanning unit 48 in the abnormal area identifying step S34 (NO in S36), after the abnormal area identifying step S34 and S36, the processing flows to the main processing step S50 without the processing condition changing step S42 being performed.

FIG. 10 is a view illustrating the main processing step S50 of applying laser processing to the workpiece 21 with use of the laser processing apparatus 2. Note that, in FIG. 10, in consideration of easy-viewing of the drawing, hatching in the workpiece 21 is omitted. First, explanation will be given of the workpiece 21. The workpiece 21 to be subjected to LLO processing includes an epitaxy substrate 23, a buffer layer 25, an optical device layer 27, a joining layer 29, and a relocation substrate 31.

On one side of the epitaxy substrate 23, the buffer layer 25 including a plurality of buffer areas each having an island shape is provided. The buffer areas are formed by the buffer layer 25 being divided into a grid pattern in plan view. The buffer areas each have a function of, for example, reducing the degree of lattice mismatch between the epitaxy substrate 23 and the optical device. While the material of the buffer area is determined according to the optical device, for example, a semiconductor material exemplified by gallium nitride (GaN), aluminum gallium nitride (AlGaN), and the like may be used.

The optical device layer 27 is provided in such a manner as to be in contact with the buffer layer 25 and includes a plurality of optical devices each having an island shape. One optical device is formed at a position corresponding to one buffer area. Each of the optical devices has substantially the same thickness. The optical device is, for example, a micro LED. The optical device includes a first electrode as an anode and a second electrode as a cathode (both of which are not illustrated). Further, the optical device includes a compound semiconductor formed by a combination of a group-III element and a group-V element.

The compound semiconductor configuring the optical device includes GaN described above, gallium phosphide (GaP), indium gallium phosphide (GaInP), indium gallium arsenide (GaInAs), indium gallium arsenide phosphide (InGaAsP), indium phosphide (InP), indium nitride (InN), indium arsenide (InAs), aluminum nitride (AlN), and aluminum gallium arsenide (AlGaAs). The optical device layer 27 is fixed to the relocation substrate 31 via the joining layer 29. The joining layer 29 is formed of an alloy such as silver tin (AgSn) or gold tin (AuSn), pure metal such as gold (Ag), platinum (Pt), chromium (Cr), indium (In), or palladium (Pd), or an organic substance such as resin.

The relocation substrate 31 is a silicon (Si) single crystal substrate having substantially the same rectangular shape as the epitaxy substrate 23. Yet, the relocation substrate 31 may be a copper (Cu) substrate, a molybdenum (Mo) substrate, or the like having the same shape. In this manner, by the optical device layer 27 being sandwiched by the epitaxy substrate 23 and the relocation substrate 31 and fixed, the workpiece 21 is formed.

In the main processing step S50, by the buffer layer 25 being broken by the laser beam L, the fixation between the epitaxy substrate 23 and the optical device layer 27 is reduced, and an optical device layer 27 fixed to the relocation substrate 31 via the joining layer 29 is formed. As illustrated in FIG. 10, when the main processing step S50 is to be performed, a workpiece unit 37 in which the workpiece 21 is supported by the ring frame 35 via the tape 33 is placed on the chuck table 26. At this time, the epitaxy substrate 23 is exposed upward, and the relocation substrate 31 faces the holding surface 26a via the tape 33.

Next, while the workpiece 21 is held under suction on the holding surface 26a via the tape 33, the ring frame 35 is clamped by the clamp units 26b. In this state, the chuck table 26 is caused to stand still right below the laser beam scanning unit 48. Further, by the buffer layer 25 disposed substantially parallel to the X-Y plane being scanned with the laser beam L by the laser beam scanning unit 48, the laser beam L is applied to the buffer layer 25 in whole. As a result, laser processing is applied to the buffer layer 25.

In the present embodiment, in a case where any abnormality is detected in the laser beam scanning unit 48, changing the processing conditions makes it possible to reduce the influence of abnormality in the laser beam scanning unit 48 in the main processing step S50. Hence, at the time of applying laser processing to the workpiece 21, insufficient breaking of the buffer layer 25 due to the processing performance of the laser processing apparatus 2 can be prevented.

### Modification

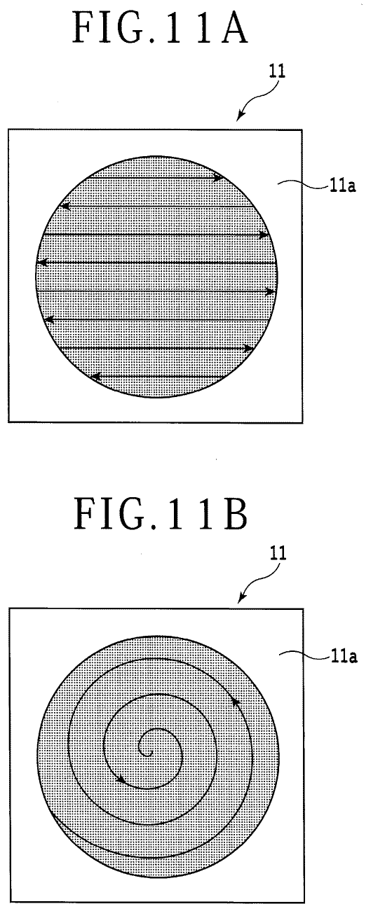

Next, with reference to FIGS. 11A and 11B, a modification will be described. In the laser processing step S10 according to the embodiment, laser processing is applied to the whole of the other side 11a of the inspection substrate 11, but laser processing may be applied to only a portion of the other side 11a. As illustrated in FIGS. 11A and 11B, the inspection substrate 11 according to the modification has a rectangular plate-shape and is subjected to laser processing only at a circular area of the central portion in the rectangular other side 11a.

FIG. 11A is a view illustrating an outline of one example of the movement path of the focused spot in the laser processing step S10 according to the modification, while FIG. 11B is a view illustrating an outline of another example of the same movement path. In short, the application range in the laser processing step S10 is adjusted such that the application range of the laser beam L in the laser processing step S10 and the application range of the laser beam L in the main processing step S50 become identical in three points: (1) the shape, (2) the area, and (3) the relative positional relation of the irradiated range with respect to the external shape.

In addition, structures, methods, and the like according to the embodiment can appropriately be modified within the range not departing from the object of the present invention. For example, the abnormal area identifying step S34 and step S36 of determining the presence or absence of the abnormal area 11d₁ and the like may be performed not by the controller 60 but by the operator. Specifically, the operator performs identification of the abnormal area and registration of coordinates of the abnormal area while looking at the images 11c.

Further, in the abovementioned imaging step S20, a plurality of images 11c are obtained by an area sensor camera or a line sensor camera, but, depending on the performance of the microscopic camera unit 54, the size of the processing marks 19, and the like, the entire area irradiated with the laser beam L may be imaged at once, and one image 11c may be obtained.

Incidentally, in the laser processing step S10 and the main processing step S50, the position of the focused spot of the laser beam L in the Z-axis direction is normally constant, but may appropriately be changed according to the mode of the laser processing to be applied to the workpiece 21 such that the position becomes the same as that in the laser processing applied to the workpiece 21. Further, the scanning speed and the energy density of the laser beam L may also appropriately be changed according to the mode of the laser processing to be applied to the workpiece 21 such that the scanning speed and the energy density become the same as those in the laser processing applied to the workpiece 21.

Note that, in the main processing step S50, the processing conditions are locally changed in areas corresponding to the abnormal areas 11d₁, 11d₂, and 11d₃ while the buffer layer 25 is scanned with the laser beam L, but instead, local application of the laser beam L may be added to the areas corresponding to the abnormal areas 11d₁, 11d₂, and 11d₃, after the buffer layer 25 has been scanned in whole with the laser beam L. As described above, even in a case where local application of the laser beam L is added, processing conditions different from those applied to the normal area 11e are applied to the areas corresponding to the abnormal areas 11d₁, 11d₂, and 11d₃ in the sense that the laser beam L is applied a plurality of times.

Incidentally, in the laser processing step S10, while the inspection substrate unit 17 in which the inspection substrate 11, the tape 13, and the ring frame 15 are integrated is held under suction on the holding surface 26a, the tape 13 and the ring frame 15 may be omitted, and the inspection substrate 11 may directly be held under suction on the holding surface 26a in a manner in which the one side 11b is in contact with the holding surface 26a. Similarly, also in the main processing step S50, in place of the workpiece unit 37 in which the workpiece 21, the tape 33, and the ring frame 35 are integrated, the tape 33 and the ring frame 35 may be omitted, and the workpiece 21 may directly be held under suction on the holding surface 26a in a manner in which the relocation substrate 31 is in contact with the holding surface 26a.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. An inspection method for a laser processing apparatus, comprising:
a laser processing step of applying laser processing to a predetermined area of an inspection substrate by scanning the predetermined area with a pulsed laser beam by use of a laser beam scanning unit of the laser processing apparatus while causing a holding table of the laser processing apparatus to stand still in a state in which the inspection substrate is held by the holding table;
an imaging step of imaging a plurality of processing marks formed in the predetermined area, after the laser processing step; and
a determination step of determining whether or not there is any abnormality in the laser beam scanning unit, based on an image obtained in the imaging step.

2. The inspection method for a laser processing apparatus according to claim 1, wherein, in the determination step, whether or not there is any abnormality in the laser beam scanning unit is determined, based on at least one feature amount of a spacing between the plurality of processing marks formed on the inspection substrate, a size of each of the plurality of processing marks, or a shape of each of the plurality of processing marks.

3. The inspection method for a laser processing apparatus according to claim 1, wherein
the determination step includes
a storing step of storing the image obtained in the imaging step and coordinates corresponding to the image, in association with each other, by a controller of the laser processing apparatus, and
an abnormal area identifying step of identifying an abnormal area in which scanning using the laser beam by the laser beam scanning unit has become abnormal in the inspection substrate, based on the image and the coordinates stored in the storing step.

4. The inspection method for a laser processing apparatus, according to claim 1, further comprising:
an informing step of, in a case where the laser beam scanning unit is determined to have abnormality in the determination step, informing an operator of the abnormality by use of at least one of a display, an indicator light, or a speaker, by a controller of the laser processing apparatus.

5. A laser processing method of applying laser processing to a workpiece by use of a laser processing apparatus, the method comprising:
a preliminary processing step of applying laser processing to a predetermined area of an inspection substrate by scanning the predetermined area with a pulsed laser beam by use of a laser beam scanning unit of the laser processing apparatus while causing a holding table of the laser processing apparatus to stand still in a state in which the inspection substrate is held by the holding table;
an imaging step of imaging a plurality of processing marks formed in the predetermined area, after the preliminary processing step;
a storing step of storing an image obtained in the imaging step and coordinates corresponding to the image, in association with each other;
an abnormal area identifying step of identifying an abnormal area in which scanning using the laser beam by the laser beam scanning unit has become abnormal in the inspection substrate, based on the image and the coordinates stored in the storing step; and
a main processing step of applying laser processing to the workpiece by scanning the workpiece with the laser beam by use of the laser beam scanning unit, after the abnormal area identifying step, wherein,
in the main processing step, when laser processing is to be applied to the abnormal area identified in the abnormal area identifying step, processing conditions different from those applied to a normal area that is other than the abnormal area are applied.
